(19) United States
(12) Patent Application Publication
(10) Pub. No.: US 2012/0250189 A1
(43) Pub. Date: Oct. 4, 2012

(54) MAGNETIC HEAD INCLUDING SIDE SHIELD LAYERS ON BOTH SIDES OF A MR ELEMENT

(75) Inventors: Naomichi DEGAWA, Tokyo (JP); Takumi Yanagisawa, Tokyo (JP); Satoshi Miura, Tokyo (JP); Yoshikazu Sawada, Tokyo (JP); Takahiko Machita, Tokyo (JP); Kenzo Makino, Tokyo (JP); Takekazu Yamane, Tokyo (JP); Shohei Kawasaki, Tokyo (JP)

(73) Assignee: TDK Corporation, Tokyo (JP)

(21) Appl. No.: 13/074,272

(22) Filed: Mar. 29, 2011

(51) Int. Cl. G11B 5/39; G11B 5/60

(52) U.S. Cl. 360/235.4; 360/319; G9B/5.114; G9B/5.229

(57) ABSTRACT

A magnetic head that reads information of a magnetic recording medium is provided. The magnetic head according to one embodiment includes: an MR element, formed with multilayer films, of which an electrical resistance changes according to an external magnetic field; a first shield layer that is disposed on a lower side in an lamination direction of the MR element; a second shield layer that is disposed on an upper side in the lamination direction of the MR element, and that applies voltage to the MR element together with the first shield layer; and side shield layers that are disposed on both sides of the MR element in a truck width direction. The side shield layers include soft magnetic layers and hard magnetic layers magnetized in a predetermined direction.

### TECHNICAL FIELD

The present invention relates to a magnetic head and particularly relates to a thin film magnetic head including side shield layers disposed on both sides of a magneto resistance (MR) element.

### BACKGROUND

As a reading part of a thin film magnetic head, an MR element configured with a multilayer film is known. Conventionally, current in plane (CIP) elements where a sense current flows in a direction within a film plane have been mostly used. Recently, in order to cope with further high density recording, current perpendicular to the plane (CPP) elements where a sense current flows in a direction orthogonal to a film plane have been developed. As this type of elements, tunnel magneto-resistance (TMR) elements to which a TMR effect is used and CPP-giant magneto resistance (GMR) elements to which a CPP-GMR effect is used are known.

An example of the GMR element or the TMR element is an element provided with a spin valve film (hereinafter, referred to as SV film). The SV film is a multilayer film including a pinning layer, a pinned layer, a spacer layer and a free layer. The pinned layer is a ferromagnetic layer of which a magnetization direction is pinned against an external magnetic field. The free layer is a ferromagnetic layer of which a magnetization direction changes according to an external magnetic field. The spacer layer is sandwiched by the pinned layer and the free layer. The pinning layer is disposed for pinning the magnetization direction of the pinned layer, and typically is configured with an anti-ferromagnetic layer. The SV film is sandwiched by a pair of shields that are electrodes for supplying a sense current.

In a typical MR element, as disclosed in U.S. Pat. No. 7,817,381B2, hard magnetic layers are disposed on both sides of an SV film in a track width direction with insulating films therebetween. The hard magnetic layers are referred to as bias magnetic layers. These bias magnetic layers apply a bias magnetic field to the free layer so as to change the free layer to a single magnetic domain. Changing the free layer to a single magnetic domain increases a linearity of a resistance change according to the change of an external magnetic field and also is advantageous for suppressing the Barkhausen noise. The magnetization direction of the bias magnetic layer is pinned in the track width direction. In the present specification, the track width direction means a direction parallel to a direction that defines a track width of a recording medium when a slider including the MR element faces the recording medium.

However, in correspondence with the recent improvement of a recording density of a magnetic recording media, a side reading problem, which a magnetic head reads magnetic information leaking from adjacent tracks, occurs.

In order to cope with the side reading problem, U.S. Patent Application Publication No. 2005/0270702A1 discloses a thin film magnetic head provided with soft magnetic layers on both sides of an MR element in the track width direction. Since a soft magnetic material absorbs a magnetic flux from adjacent tracks, a noise effect due to the magnetic flux from the adjacent tracks is suppressed. As a result, a thin film magnetic head that is compatible with a recording medium of high recording density can be provided.

However, the soft magnetic layers do not have the function that applies a bias magnetic field to the MR element. Accordingly, the MR element disclosed in U.S. Patent Application Publication 2005/0270702A1 has a special film configuration. Specifically, two free layers of which magnetization directions change according to an external magnetic field and an antiferromagnetic coupling layer disposed between the free layers. The antiferromagnetic coupling layer let one free layer and the other free layer interact to each other. In this way, the antiferromagnetic coupling layer lets both of the free layers to have a self bias function. However, with such a bias function, sufficient bias is occasionally not applied to the free layers. Similarly, since only specific materials can be used for the antiferromagnetic coupling layer as a spacer that defines the distance between the free layers, it becomes difficult to improve the performance of the MR element.

As described above, it is difficult to apply sufficient bias to the free layers while the function of side shielding is maintained. Therefore, a thin film magnetic head that can apply sufficient bias to the free layers while the function of side shielding is desired.

### SUMMARY

A magnetic head of one embodiment that reads information of a magnetic recording medium includes: a magneto resistance effect element (MR element), formed with multilayer films, of which an electrical resistance changes according to an external magnetic field; a first shield layer that is disposed on a lower side in a lamination direction of the MR element; a second shield layer that is disposed on an upper side in the lamination direction of the MR element and that applies voltage to the MR element together with the first shield layer; and side shield layers that are disposed on both sides of the MR element in a first direction, the first direction being orthogonal to the lamination direction of the MR element and parallel to a surface facing the magnetic recording medium. The side shield layers include soft magnetic layers and hard magnetic layers magnetized in a predetermined direction.

In the above-described magnetic head, because the side shield layers include the soft magnetic layers, the function that the side shield layers absorb a magnetic field applied to the both sides of the MR element is maintained. Also, the hard magnetic layers having magnetizations magnetize the soft magnetic layers in a predetermined direction. This allows the side shield layers to apply a bias magnetic field to the MR element, especially to a free layer. In that manner, the above-described magnetic head obtains the ability to apply sufficient bias to the free layer while the function of side shielding is maintained.

The above description, as well as other objects, features, and advantages of the present invention will be evident by the following description with reference to the attached drawings exemplifying the present invention.

### BRIEF DESCRIPTION OF DRAWINGS

FIG. 1 is a schematic cross-sectional view of a thin film magnetic head including a reading part and a writing part.

FIG. 2 is a schematic plan view of a reading part of a magnetic head according to a first embodiment, as seen from an air bearing surface.

FIG. 3 is a view explaining the principle of performance of the magnetic head;

FIG. 4 is a schematic plan view of a reading part of a magnetic head according to a second embodiment, as seen from the air bearing surface.

FIG. 5 is a flow diagram illustrating an order of an annealing treatment of a pinning layer of the MR element, an annealing treatment of an antiferromagnetic layer configuring an anisotropy application layer, and a magnetization treatment of hard magnetic layers configuring side shield layers.

FIG. 6 is a schematic plan view of a reading part of a magnetic head according to a third embodiment, as seen from the air bearing surface.

FIG. 7 is a schematic plan view of a reading part of a magnetic head according to a fourth embodiment, as seen from the air bearing surface.

FIG. 8 is a schematic plan view of a reading part of a magnetic head according to a fifth embodiment, as seen from the air bearing surface.

FIG. 9 is a schematic cross-sectional view of the reading part of the magnetic head along the 9A-9A line of FIG. 4.

FIG. 10 is a schematic cross-sectional view of the reading part of the magnetic head along the 10A-10A line of FIG. 4.

FIG. 11 is a schematic cross-sectional view of the reading part of the magnetic head along the 11A-11A line of FIGS. 9 and 10.

FIG. 12 is a plan view of a wafer in related to the manufacture of the magnetic head;

FIG. 13 is a perspective view of a slider.

FIG. 14 is a perspective view of a head arm assembly including a head gimbal assembly in which a slider is incorporated.

FIG. 15 is a side view of a head arm assembly in which the slider is incorporated.

FIG. 16 is a plan view of the hard disk device in which the slider is incorporated.

### DETAILED DESCRIPTION OF THE INVENTION

Hereinafter, explanations regarding embodiments of the present invention are given with reference to the drawings. The following embodiment explains a thin film magnetic head that reads information of a hard disk; however, the present invention can be applied to a magnetic head that reads information of an arbitrary magnetic recording medium.

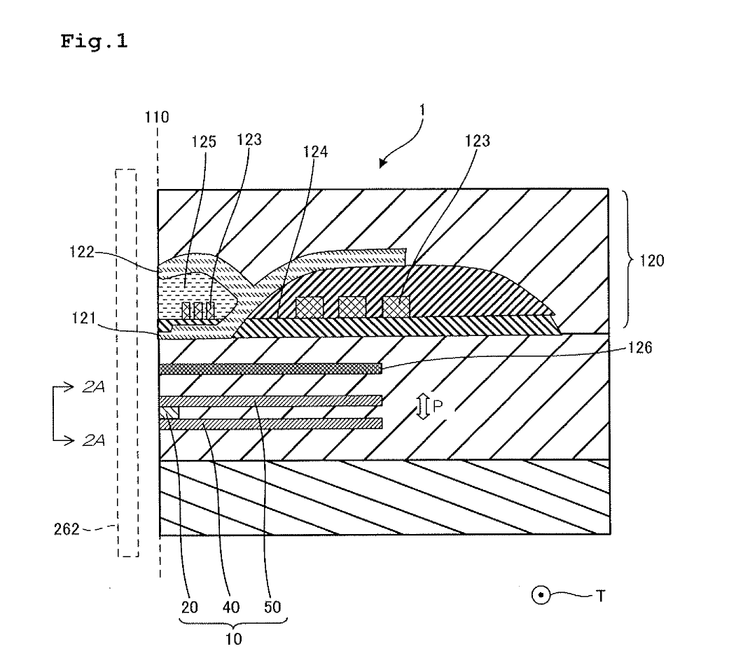

FIG. 1 is a schematic cross-sectional view of a thin film magnetic head. A thin film magnetic head 1 is a composite head including a reading part 10 that reads information from a magnetic recording medium and a writing part 120 that writes information to the magnetic recording medium. Instead, the thin film magnetic head may be a magnetic head, being exclusively for reading, including only the reading part 10.

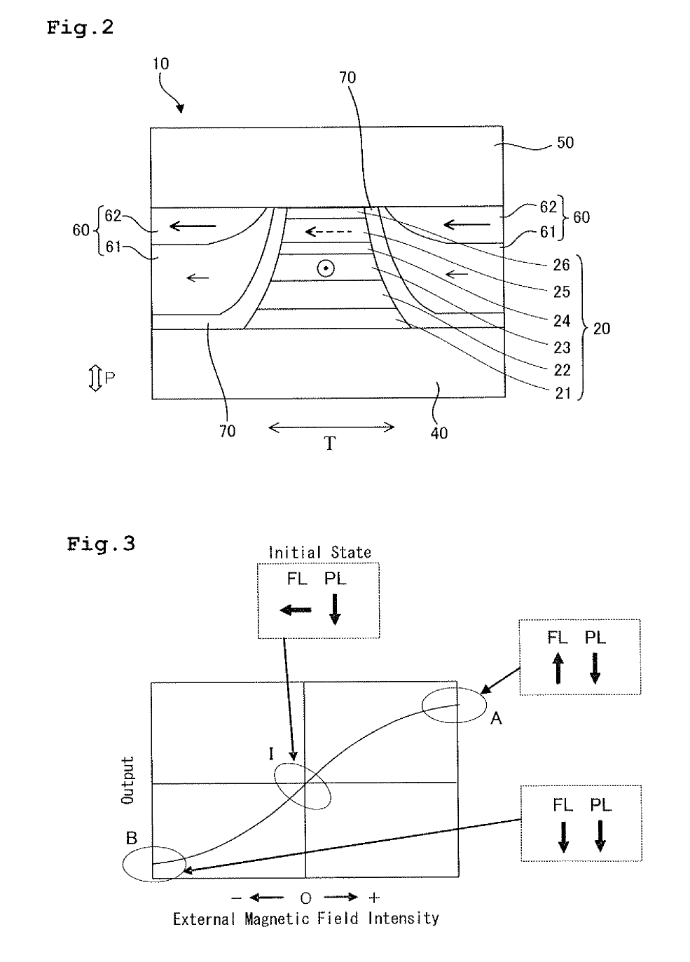

FIG. 2 is a schematic plan view of the reading part 10 of the magnetic head 1 of a first embodiment, as seen from the 2A-2A direction of FIG. 1, i.e., a surface 110 that faces a recording medium 262. In the magnetic head that reads information of a hard disk, the surface 110 of the magnetic head 1 that faces the recording medium 262 is referred to as an air bearing surface (ABS). Note, in a magnetic head that reads information of a magnetic tape, the surface 110 that faces the recording medium 262 is occasionally referred to as a tape bearing surface. Note, the solid arrows in the drawing illustrate magnetization directions of the respective layers, and the dotted arrow illustrates a direction of a bias applied to a free layer.

The reading part 10 includes a magneto resistance (MR) element 20 of which an electrical resistance changes according to an external magnetic field and shield layers 40, 50 and 60 that surround the MR element 20. The MR element 20 is arranged in a manner of facing the recording medium 262. The MR element 20 is configured with multilayer films 21-26 including a plurality of layers.

A magnetic field of the recording medium 262 at a position of facing the MR element 20 changes with the movement of the recording medium 262. When the MR element 20 detects the change of this magnetic field as the change of electrical resistance, the magnetic head 1 reads magnetic information written in respective magnetic domains of the recording medium 262.

A first shield layer 40 is disposed on a lower side of the MR element 20 in a lamination direction P. A second shield layer 50 is disposed on an upper side of the MR element 20 in the lamination direction P. The first shield layer 40 and the second shield layer 50 function as electrodes that apply voltage to the MR element 20 and that let a sense current flow in the lamination direction P of the MR element 20. The first shield layer 40 and the second shield layer 50 can be each configured with a magnetic layer composed of NiFe, CoFe, NiCoFe, FeSiAl or the like, and each having a thickness of, for example, approximately 1 μm.

The side shield layers 60 are disposed on both sides of the MR element in a first direction T that is orthogonal to the lamination direction P of the MR element and that is parallel to the surface 110 facing the magnetic recording medium. The first direction T corresponds to a track width direction.

The side shield layers 60 include soft magnetic layers 61 and hard magnetic layers 62 that are magnetized in a predetermined direction. It is preferred that the soft magnetic layers 61 are adjacent to the MR element 20 with insulators 70 therebetween. For the soft magnetic layers 61, NiFe, CoFe and NiCoFe, for example, can be used. For the hard magnetic layers 62, CoPt, FePt, CoFe, CoCrPt and NiFe, for example, can be used. The side shield layers 60 may include under layers composed of, for example, Ta, Ru, Hf, Nb, Zr, Ti, Mo, Cr, W or the like on lower sides of the hard magnetic layers 62 as necessary.

The insulating layers 70 are disposed between the MR element 20 and the side shield layers 60. The insulating layers 70 can be formed of Al₂O₃ or the like.

The magnetic head 1 of the present invention can include an arbitrary MR element 20 provided with a free layer 25 that is to be changed into a single magnetic domain by a bias magnetic field. A description regarding one example of a configuration of the MR element 20 is given hereinafter.

The MR element 20 is a spin valve film including a buffer layer 21, a pinning layer 22, a pinned layer 23, a spacer layer 24, the free layer 25 and a cap layer 26.

The pinned layer 23 is a ferromagnetic layer of which a magnetization direction is pinned against an external magnetic field. The free layer 25 is a ferromagnetic layer of which a magnetization direction changes according to an external magnetic field. For the pinned layer 23, a multilayer film in which CoFeB, Ru, CoFe or the like, for example, are laminated can be used. For the free layer 25, a multilayer film configured with a CoFe layer and a NiFe layer, for example, can be used.

The buffer layer 21 is disposed as a base for the pinning layer 22. For the buffer layer 21, a Ta layer, an NiCr layer or a multilayer film configured with a Ta layer and a Ru layer can be used. The pinning layer 22 is disposed for pinning the magnetization direction of the pinned layer 23. The pinning layer 22 includes an antiferromagnetic layer such as IrMn, PtMn, RuRdMn, FeMn or the like.

An annealing treatment that raises a temperature to more than a blocking temperature of the antiferromagnetic layer and decreases the temperature in a predetermined magnetic field is performed on the antiferromagnetic layer in the pinning layer 22. As a result, the magnetization direction of the pinned layer 23 is pinned in a predetermined direction.

The spacer layer 24 is disposed so as to increase a separation between the free layer 25 and the pinned layer 23. For the spacer layer 24, various materials such as Cu, AlOx, MgO or the like can be used. It is preferred that the spacer layer 24 is a nonmagnetic layer; however, the spacer layer is not limited to the nonmagnetic layer. When the spacer layer 24 is an insulating layer, a tunnel current that goes through the insulating layer flows in the MR element 20. The cap layer 26 is disposed to prevent the deterioration of the respective laminated layers. For the cap layer 26, a multilayer film configured with a Ru layer and a Ta layer, or the like, is used.

The magnetization direction of the free layer 25 rotates according to an external magnetic field and forms an angle with respect to the magnetization direction of the pinned layer 23. Depending on the angle between the magnetization direction of the free layer 25 and the magnetization direction of the pinned layer 23, the electrical resistance of the MR element 20 changes.

Soft magnetic materials have the function to absorb a magnetic field. Accordingly, a magnetic field applied to the both sides of the MR element 20 in the track width direction T is effectively absorbed by the soft magnetic layers 61. In this way, the function to shield a magnetic field on the both sides of the MR element 20 in the track width direction T is maintained.

As described above, the hard magnetic layers 62 configuring the side shield layers 60 are magnetized in a predetermined direction. Since the hard magnetic layers 62 have high coercive force, the magnetization directions of the hard magnetic layers 62 rarely change even when a magnetic field is applied during the usage of the magnetic head.

The soft magnetic layers 61 are magnetized in a predetermined direction by the hard magnetic layers 62. The side shield layers 60 obtain the function that applies a bias magnetic field to the MR element 20, in particular to the free layer 25, due to the magnetizations of the soft magnetic layers 61 and the hard magnetic layers 62.

The soft magnetic layers 61 are positioned on lower sides of the hard magnetic layers 62 in the lamination direction P. In this case, it is preferred that the soft magnetic layers 61 are extended along respective one surfaces of the side shield layers facing the MR element 20. Since the soft magnetic layers 61 with the function absorbing a magnetic field are adjacent to the MR element 20, the function, which shields the magnetic field on the both sides of the MR element 20 in the track width direction T, is improved.

The soft magnetic layers 61 having such a shape can be easily manufactured by forming the MR film 20 above the first shield layer 40 at first and then forming the soft magnetic layers 61 by a sputtering or the like. This is because, when the soft magnetic layers 61 are evaporated and deposited on an area with a projection by a sputtering or the like, at least inclined surfaces as illustrated in FIG. 2 are formed.

In the example illustrated in FIG. 2, the soft magnetic layers 61 are positioned on the lower sides of the hard magnetic layers 62 in the lamination direction P; however, the soft magnetic layers 61 may be also positioned on upper sides of the hard magnetic layers as long as sufficient shield effect is exerted. Also, each of the soft magnetic layers 61 configuring the side shield layers 60 may be also configured with a plurality of layers that are exchange-coupled with each other with a nonmagnetic layer therebetween.

FIG. 3 is a conceptual view illustrating the principle of performance of the MR element 20 of the present embodiment. The horizontal axis indicates the external magnetic field intensity that is applied to the MR element 20. The vertical axis indicates the output of the MR element 20. The output may be also either the resistance value of the MR element 20 or the voltage value depending on the change of the resistance value. Alternatively, the current value may be also used as the output. In this case, it should be noted that the magnitude relationship of the output is inverted. Note, in the drawing, the magnetization direction of the free layer 25 is referred as FL, and the magnetization direction of the pinned layer 23 is referred as PL.

In the state (I) where no external magnetic field is applied from the recording medium (the initial state), the magnetization direction FL of the free layer 25 forms an angle of substantially 90 degrees with respect to the magnetization direction PL of the pinned layer 23 due to the bias magnetic field from the side shield layers 60. Then, when the external magnetic field from the recording medium 262 is applied to the MR element, the magnetization direction FL of the free layer 25 changes. Depending on the direction of the external magnetic field, the relative angle between the magnetization direction FL of the free layer 25 and the magnetization direction PL of the pinned layer 23 increases (the anti-parallel state) or decreases (the parallel state). As both of the magnetization directions come closer to the anti-parallel state, electrons supplied from the electrodes are more likely to be scattered so that the electric resistance value of the sense current is increased (Portion A in the drawing). As the magnetization directions come closer to the parallel state, electrons supplied from the electrodes are less likely to be scattered so that the electric resistance value of the sense current is decreased (Portion B in the drawing). In this way, the magnetic head 1 can detect the external magnetic field using the change of the relative angle between the magnetization direction of the free layer 25 and the magnetization direction of the pinned layer 23.

The side shield layers 60 apply a bias magnetic field to the free layer 25 (see also the dotted arrow in FIG. 2) such that the magnetization of the free layer 25 in the initial state is oriented in a predetermined direction. The dotted arrow in FIG. 2 illustrates one example of the orientation of the bias magnetic field applied to the free layer 25 of the MR element 20. The orientation of the bias magnetic field is arbitrarily set depending on a film configuration of the MR element, an usage purpose of the magnetic head or the like.

It is preferred that the magnetization direction of the free layer 25 in the state where no external magnetic field is applied, i.e., the initial state (I), is oriented substantially in the track width direction T. In this case, it is preferred that the magnetization direction of the pinned layer 23 is oriented in a direction substantially perpendicular to the air bearing surface 110. For this purpose, the magnetization directions of the hard magnetic layers 62 configuring the side shield layers 60 are also oriented substantially in the track width direction T.

Regarding the magnetic head of the first embodiment and a magnetic head of a comparative example in which the soft magnetic layers 61 of the side shield layers of the magnetic head according to the first embodiment was replaced with hard magnetic layers, effective widths MRW of the respective MR elements 20 were actually measured. The effective width MRW of the MR element is a width, which is measured based on the output signal of the MR element, of the MR element in the track width direction T. More specifically, the effective width MRW is measured based on the width of the output distribution when the output value is the half of the peak value of the output distribution. The larger the effective width MRW is, the more the side reading problem, which magnetic information leaking from adjacent tracks of the magnetic recording medium is read, occurs.

The effective width MRW of the MR element 20 of the first embodiment was decreased by approximately 7-8% with respect to the effective width MRW of the MR element of the comparative example. This was considered that the shield effect of the side shield layers 60 was exerted.

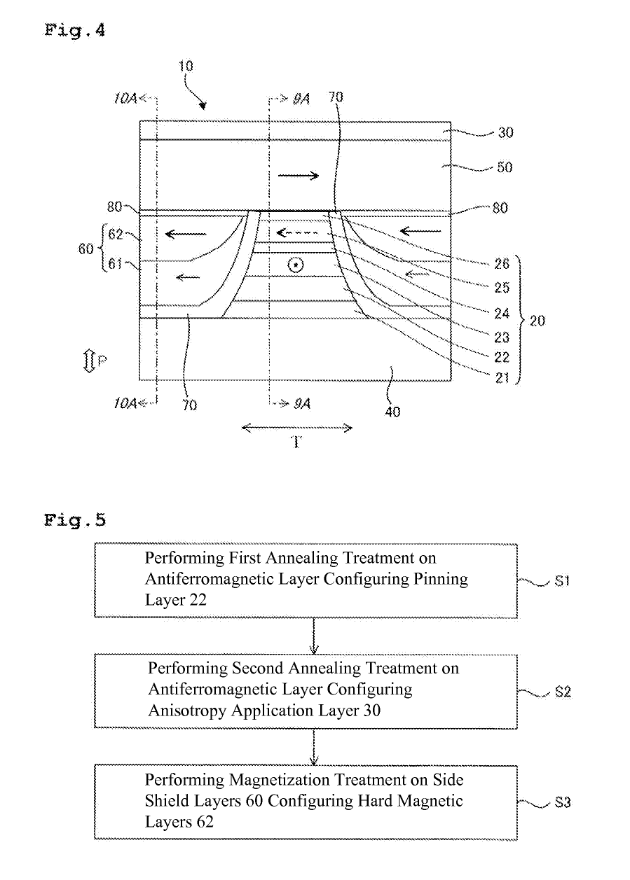

FIG. 4 is a schematic plan view of a reading part 10 of a magnetic head 1 according to a second embodiment, seen from the surface 110 facing the recording medium 262. Note, the solid arrows in the drawing illustrate magnetization directions of the respective layers, and the dotted arrow illustrates an orientation of a bias applied to a free layer.

In the magnetic head 1 of the second embodiment, configurations of first and second shield layers 40 and 50 and side shield layers 60 are almost the same as the first embodiment. The magnetic head 1 of the second embodiment further includes an anisotropy application layer 30 disposed on an opposite side of the MR element with respect to the second shield layer 50. For the anisotropy application layer 30, an antiferromagnetic layer composed of IrMn, PtMn, RuRdMn, FeMn or the like or a hard magnetic layer composed of CoPt, CoCrPt, FePt or the like can be used.

A configuration of the MR element 20 is almost the same as the configuration explained in the first embodiment. The anisotropy application layer 30 provides an exchange magnetic anisotropy to the second shield layer 50 so as to magnetize the second shield layer 50 in a predetermined direction. In FIG. 4, the second shield layer 50 is magnetized in the right orientation; however, it should be noted that the direction of the magnetization is not particularly limited.

When the magnetic head 1 includes the anisotropy application layer 30 configured with the antiferromagnetic layer, it is preferred that nonmagnetic conductor layers 80 are disposed between the side shield layers 60 and the second shield layer 50. For the nonmagnetic conductor layers 80, a material that generates no magnetic mutual influence between the side shield layers 60 and the second shield layer 50 is used. Such a nonmagnetic conductor is, for example, Ta, Ru, Hf, Nb, Zr, Ti, Mo, Cr, W or the like. The nonmagnetic conductor layers 80 may be also positioned between the MR element 20 and the second shield layer 50.

When the anisotropy application layer 30 is the antiferromagnetic layer, an annealing treatment that raises a temperature to more than a blocking temperature of the antiferromagnetic layer and decreases the temperature in a predetermined magnetic field is performed on the antiferromagnetic layer. As are result, the magnetization direction of the second shield layer 50 is pinned in a predetermined direction. It is preferred that the magnetization direction of the second shield layer 50 is in a direction parallel or anti-parallel to the magnetization direction of the free layer 25 in the initial state.

As illustrated in the example of FIG. 3, the magnetization direction of the pinned layer 23 of the MR element 20 and the magnetization direction of the free layer 25 are normally oriented in mutually different directions in the initial state. Therefore, when the pinning layer 22 and the pinned layer 23 receive the influence of the magnetic field generated by the magnetizations of the second shield layer 50 and the side shield layers 60 during the annealing treatment on the antiferromagnetic layer of the pinning layer 22, the magnetization direction of the pinned layer 23 deviates from the preferred direction. The deviation of the magnetization direction contributes to the noise and output decrease of the magnetic head.

Therefore, the annealing treatment of the pinning layer 22 of the MR element 20, the annealing treatment of the antiferromagnetic layer configuring the anisotropy application layer 30, and a magnetization treatment of the hard magnetic layers 62 configuring the side shield layers 60 are preferably performed in the following order (see also FIG. 5).

At first, a first annealing treatment is performed on the antiferromagnetic layer configuring the pinning layer 22 (S1). It is preferred that the first annealing treatment is performed when the multilayer films configuring the MR element 20 is deposited above the first shield layer 40. More specifically, it is preferred to perform the first annealing treatment after that the multilayer films, such as the pinning layer 22, the pinned layer 23 or the like, configuring the MR element 20 are deposited and before that a milling treatment, which removes unnecessary portions of the above-described multilayer films in order to form the side shield layers 60 on the both sides of the MR element 20, is performed. The annealing treatment is performed in a predetermined external magnetic field as described above.

Next, portions of the above-described multilayer films are removed to form the MR element 20 in a determined shape, the side shield layers 60 are formed on the both sides of the MR element 20, and the second shield layer 50 and the anisotropy application layer 30 are formed above the MR element 20 and the side shield layers 60. Then, a second annealing treatment is performed on the antiferromagnetic layer configuring the anisotropy application layer 30 (S2). Then, a magnetization treatment is performed on the hard magnetic layers 62 configuring the side shield layers 60 (S3).

In the case of performing the magnetization treatment at the end as described above, the side shield layers 60 are not magnetized during the first and second annealing treatments. Accordingly, the bias magnetic field from the side shield layers 60 are not applied to the pinned layer 23 or the pinning layer 22 during the first and second annealing treatments so that the deviation of the magnetization direction of the pinned layer 23 from the preferred direction is suppressed. Note, in the magnetization treatment, it is unnecessary to heat the reading part 10 to a high temperature and it is only necessary to apply the magnetic field to the side shield layers 60. In other words, since the temperature is maintained to be sufficiently lower than the blocking temperature of the antiferromagnetic layer configuring the pinning layer 22 during the magnetization treatment, the deviation of the magnetization of the pinned layer 23 is suppressed. As a result, the deviation of the magnetization direction of the pinning layer 22 is also suppressed.

Also, the nonmagnetic conductor layers 80 cut off the magnetic coupling, i.e., exchange coupling or magnetostatic coupling, between the side shield layers 60 and the second shield layer 50. When the magnetic conductor layer 80 are not disposed and the second shield layer 50 and the side shield layers 60 are magnetically coupled, the side shield layers 60 are occasionally magnetized during the second annealing treatment. In this case, the magnetization of the pinned layer 23 of the MR element 20 is occasionally tilted by the magnetizations of the side shield layers 60 during the second annealing treatment.

In the present embodiment, the cut off of the magnetic coupling by the nonmagnetic conductor layers 80 can suppress that the side shield layers 60 are magnetized during the second annealing treatment. Thereby, the magnetic influence provided to the pinned layer 23 of the MR element 20 during the second annealing treatment is suppressed, and as a result the deviation of the magnetization direction of the pinned layer 23 of the MR element 20 is suppressed.

In that manner, the nonmagnetic conductor layers 80 between the two antiferromagnetic layers generate an effect that, while the annealing treatment is performed on one of the antiferromagnetic layers, the influence from the other antiferromagnetic layer is reduced. Thereby, the magnetization directions of the pinned layer 23 and the second shield layer 50 become stable, and the preferred bias magnetic field can be applied to the free layer 25. As a result, the Barkhausen noise is suppressed.

In the present embodiment, the cap layer 26 of the MR element 20 may be a magnetic coupling layer having the function that magnetically couples the free layer 25 and the second shield layer 50 to each other. For the magnetic coupling layer, Ru, Rh, Cr, Cu, Ag or the like, for example, can be used.

In this case, the free layer 25 interacts ferromagnetically or antiferromagnetically with the second shield layer 50 with the magnetic coupling layer 26 therebetween. Therefore, due to the magnetization of the second shield layer 50, the free layer 25 is also magnetized in the predetermined direction. At that time, it is preferred that the direction of the magnetization provided from the second shield layer 50 to the free layer 25 due to the exchange coupling substantially corresponds to the magnetization directions of the hard magnetic layers 62. Thereby, the magnetization of the free layer 25 is more effectively biased.

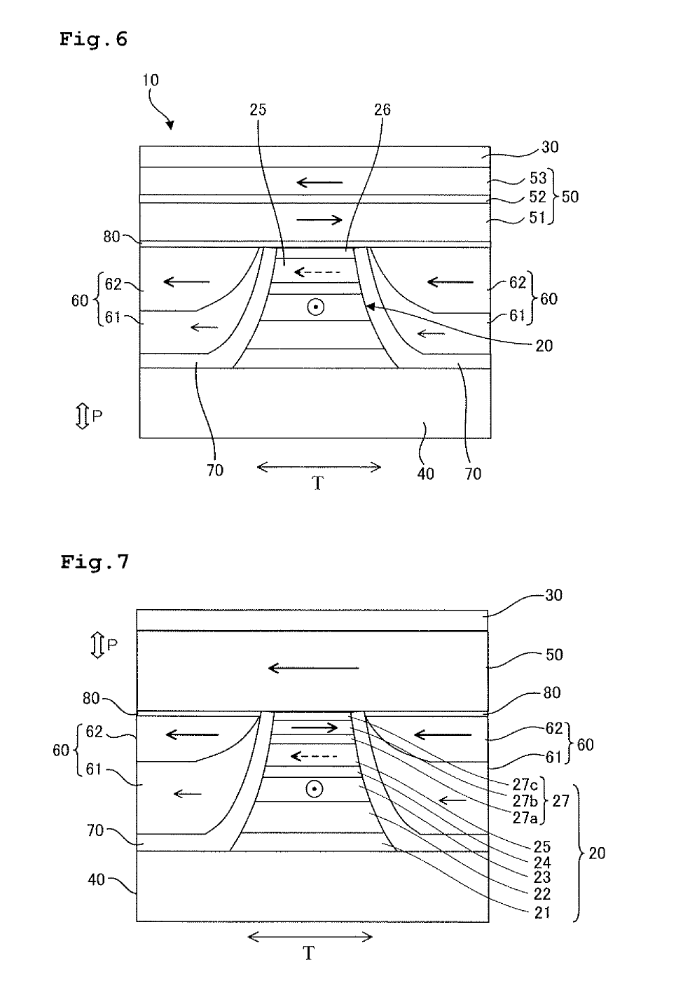

FIG. 6 is a schematic plan view of a reading part 10 of a thin film magnetic head 1 according to a third embodiment, as seen from the air bearing surface. The solid arrows in the drawing illustrate the magnetization directions of the respective layers, and the dotted arrow illustrates the direction of a bias applied to a free layer.

In the third embodiment, a second shield layer 50 includes two soft magnetic layers 51 and 53 that are exchange-coupled with each other with a magnetic coupling layer 52 therebetween. The magnetic coupling layer 52 exchange-couples the soft magnetic layer 51 on one side with the soft magnetic layer 53 on the other side. The magnetic coupling layer 52 is composed of a nonmagnetic layer such as, for example, Ru, Rh, Cr, Cu, Ag or the like. The configuration other than the above-description is similar to the second embodiment. Note, the second shield layer 50 may include a plurality of the magnetic coupling layers 52 and three or more layers of the soft magnetic layers.

As in the second embodiment, a cap layer 26 that prevents the deterioration of the respective layers of the MR element 20 may as well be a magnetic coupling layer having the function that magnetically couples the first soft magnetic layer 51 of the second shield layer 50 with the free layer 25. At this time, it is preferred that the direction of the magnetization provided to the free layer 25 via the second shield layer 50 due to the exchange coupling substantially corresponds to the magnetization direction of the hard magnetic layer 62. Thereby, the magnetization of the free layer 25 is more effectively biased.

FIG. 7 is a schematic plan view of a reading part 10 of a magnetic head 1 according to a fourth embodiment, seen from the surface 110 facing the recording medium 262. Note, the solid arrows in the drawing illustrate the magnetization directions of the respective layers, and the dotted arrow illustrates the direction of a bias applied to a free layer.

In the fourth embodiment, a portion that corresponds to the cap layer of the MR element 20 functions as a magnetic coupling layer 27 that magnetically couples a second shield layer 50 with a free layer 25. The magnetic coupling layer 27 of the MR element 20 includes nonmagnetic layers 27a and 27c disposed on both sides of a soft magnetic layer 27b in a manner of sandwiching the soft magnetic layer 27b. The soft magnetic layer 27b may be composed of, for example, NiFe, CoFe, NiCoFe or a lamination film configured with a NiFe layer, a CoFe layer and/or a NiCoFe layer. The nonmagnetic layers 27a and 27c are composed of, for example, Ru, Rh, Cr, Cu, Ag or the like. As described above, the magnetic coupling layer 27 may be also configured with a multilayer film.

The soft magnetic layer 27b is antiferromagnetically or ferromagnetically exchange-coupled with the free layer 25 with the first nonmagnetic layer 27a therebetween. Also, the soft magnetic layer 27b is antiferromagnetically or ferromagnetically exchange-coupled with the second shield layer 50 with the second nonmagnetic layer 27c therebetween. In this way, the free layer 25 and the second shield layer 50 are indirectly and magnetically coupled. Therefore, the second shield layer 50 magnetized in a preferred direction due to an anisotropy application layer 30 biases the magnetization of the free layer 25 with the magnetic coupling layer 27 therebetween. Therefore, the magnetization of the free layer 25 is more effectively biased as in the magnetic head of the second embodiment.

The present invention is not limited to the above-described embodiments and includes a magnetic head provided with a reading part in which some of the several above-described embodiments are combined to the extent possible.

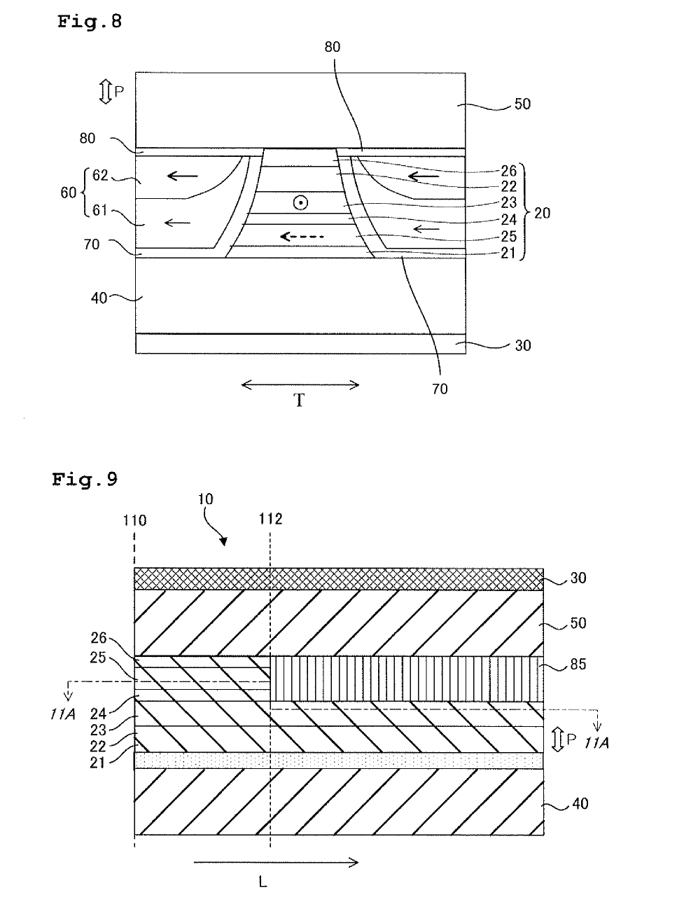

In the second to fourth embodiments, on the opposite side of the MR element 20 with respect to the second shield layer 50, the anisotropy application layer 30 is disposed on the second layer 50. However, the anisotropy application layer 30 may be also disposed on the opposite side of the MR element 20 with respect to the first shield layer 40. FIG. 8 illustrates one example of such a reading part 10.

FIG. 8 illustrates a reading part 10 of a magnetic head according to a fifth embodiment. The solid arrows in the drawing illustrate the magnetization directions of the respective layers, and the dotted arrow illustrates the direction of a bias applied to a free layer.

In the fifth embodiment, an MR element 20 is disposed on a first shield layer 40 with a thickness of approximately 1 μm. It is preferred that the MR element 20 is a lamination film in which a buffer layer 21, a free layer 25, a spacer layer 24, a pinned layer 23, a pinning layer 22 and a cap layer 26 are laminated in this order. In other words, the free layer 25, the spacer layer 24, the pinned layer 23 and the pinning layer 22 are laminated in the reverse order to the order explained in the second embodiment.

Side shield layers 60 are disposed on both sides of the MR element 20 in the track width direction T. The side shield layers 60 include soft magnetic layers 61 and hard magnetic layers 62 magnetized in predetermined directions. Nonmagnetic conductor layers 80 are disposed between the second shield layers 50 and the side shield layers 60.

The buffer layer 21 disposed between the first shield layer 40 and the free layer 25 may be a magnetic coupling layer having the function that antiferromagnetically or ferromagnetically exchange-couples the first shield layer 40 with the free layer 25. For the magnetic coupling layer, Ru, Rh, Cr, Cu, Ag or the like, for example, can be used.

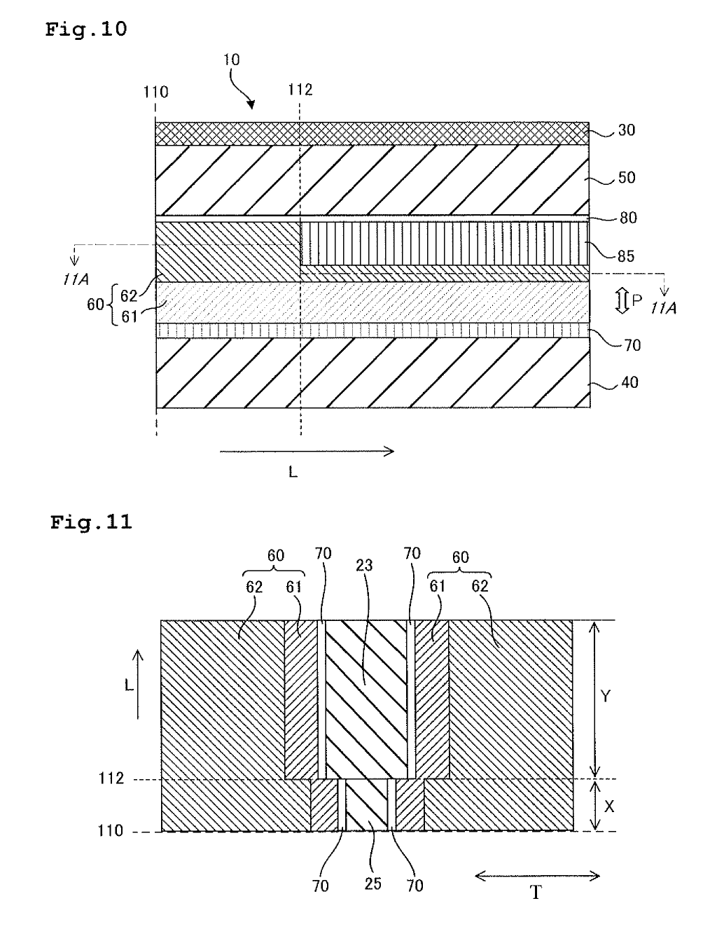

On the opposite side of the MR element 20 with respect to the first shield layer 40, an anisotropy application layer 30 is disposed under the first layer 40. The anisotropy application layer 30 may be an antiferromagnetic layer or a hard magnetic layer as in the second embodiment. The anisotropy application layer 30 provides exchange magnetic anisotropy to the first shield layer 40 and magnetizes the first shield layer 40 in a predetermined direction. In other words, the anisotropy application layer 30 provides exchange magnetic anisotropy to one of the pair of shield layers 40 and 50 that is disposed closer to the free layer 25 than the pinned layer 23 (the shield layer 40 in the case of FIG. 10) so as to magnetize the shield layer in a preferred direction.

When the buffer layer 21 functions as a magnetic coupling layer, the free layer 25 is magnetically coupled with the first shield layer 40 with the magnetic coupling layer 21 therebetween. Therefore, the first shield layer 40 biases the magnetization of the free layer 25 with the magnetic coupling layer 21 therebetween. At this time, it is preferred that the direction of the magnetization provided to the free layer 25 via the first shield layer 40 due to the exchange coupling substantially corresponds to the magnetization directions of the hard magnetic layers 62. Therefore, the magnetization of the free layer 25 is more effectively biased.

As in the second embodiment, it is also preferred that the insulators 70 are disposed between the side shield layers 60 and the first shield layer 40. These insulators 70 may be also extended between the MR element 20 and the side shield layers 60 from the viewpoint of the manufacturing. It is obvious that the similar effect obtained with the magnetic head of the second embodiment can be obtained also with the magnetic head of the fifth embodiment.

Next, one example of the configuration of a cross section, perpendicular to the track width direction T, of the reading part 10 of the magnetic head 1 is explained with reference to FIGS. 9, 10 and 11. FIG. 9 is a schematic cross-sectional view of the reading part 10 of the magnetic head along the 9A-9A line of FIG. 4. FIG. 10 is a schematic cross-sectional view of the reading part 10 along the 10A-10A line of FIG. 4. FIG. 11 is a schematic cross-sectional view along the 11A-11A line of FIGS. 9 and 10. Note, the region X of FIG. 11 illustrates a cross section at the level of the free layer 25 with respect to the lamination direction P, and the region Y illustrates a cross section at the level of the pinned layer 23 with respect to the lamination direction P.

As illustrated in FIG. 9, the pinned layer 22 configuring the MR element 20 is extended longer in the direction L orthogonal to the air bearing surface 110 than the free layer 25. Accordingly, there is the advantage in that the pinned layer 22 obtains shape magnetic anisotropy and is more likely to be magnetized in the direction L orthogonal to the air bearing surface 110. There is also an advantage in that the heat resistance performance is increased because of the increase in the volume of the pinned layer 22.

When the magnetization direction of the pinned layer 22 is oriented in the direction L orthogonal to the air bearing surface 110, it is preferred that the magnetization of the free layer 25 in the state where no external magnetic field is applied is oriented in the track width direction T. Therefore, in order not to apply the shape magnetic anisotropy to the free layer 25, the length of the free layer 25 in the direction orthogonal to the air bearing surface 110 is set to be short.

In a manufacturing process of the MR element 20 having the above-described configuration, after the multilayer film configuring the MR element 20 is formed, the rear side of the cap layer 26 and the free layer 25 in the direction orthogonal to the air bearing surface 110 is removed. At that time, portions of the side shield layers 60 on the both sides of the MR element 20 in the track width direction T are also removed (see FIG. 10). As a result, the side shield layers 60 have a step at a rear part 112 of the free layer 25 in the direction orthogonal to the air bearing surface 110. Note, the removed portions of the free layer 25 and the side shield layers 60 are embedded with an insulating layer 85.

When the MR element 20 has this type of shape, it is preferred that portions of the hard magnetic layers 62 and the soft magnetic layers 61 of the side shield layers 60 are also extended longer in the direction L orthogonal to the air bearing surface 110 than the free layer 25 (see FIGS. 10 and 11). When the hard magnetic layers 62 are extended long crossing the rear part 112 of the free layer 25, the magnetization directions of the soft magnetic layers 61 in a region from the air bearing surface 110 to the rear part 112 of the free layer 25 become stable. Therefore, the side shield layers 60 become able to apply a bias magnetic field stably to the free layer 25 of the MR element. As a result, the noise relating to the output of the MR element can be reduced.

As illustrated in FIG. 11, at the level of the free layer 25 with respect to the lamination direction P, the soft magnetic layers 61 are positioned on the both sides of the MR element 20, and further the hard magnetic layers 62 are positioned outsides of the both sides. With such a configuration, the magnetization directions of the soft magnetic layers 61 in the vicinity of the free layer 25 become stable so that a bias magnetic field can be applied effectively to the free layer 25.

The above-described reading part 10 of the thin film magnetic head 1 is manufactured by performing treatments on a wafer using a technology of film formation such as a plating method, a sputtering or the like and a patterning technology such as a milling, a photo lithography method or the like. After the recording part 10 of the magnetic head 1 is manufactured, a writing part 120, which is explained below, may be formed above the reading part 10 as necessary. After the formation of the writing part 120, a wafer on which MR elements are formed is divided into bars, and an air bearing surface 110 is formed by a polishing. Moreover, the bar is divided into sliders, processes such as washing, examination or the like are performed, and thereby a slider, which is described later, is completed.

Next, a detail description regarding a configuration of the writing part 120 is give with reference to FIG. 1. The writing part 120 is disposed above the reading part 10 with an interelement shield 126, being formed by a sputtering method or the like, therebetween. The writing part 120 has a configuration for so-called perpendicular magnetic recording. A magnetic pole layer for writing is formed of a main magnetic pole layer 121 and an auxiliary magnetic pole layer 122. These magnetic pole layers 121 and 122 are formed by a frame plating method or the like. The main magnetic pole layer 121 is formed of FeCo and is exposed in an orientation nearly orthogonal to the air bearing surface 110 on the air bearing surface 110. A coil layer 123 extending over a gap layer 124 composed of an insulating material is wound around the periphery of the main magnetic pole layer 121 so that a magnetic flux is induced to the main magnetic pole layer 121 by the coil layer 123. The coil layer 123 is formed by a frame plating method or the like. The magnetic flux is guided within the main magnetic pole layer 121 and is extended from the air bearing surface 110 towards the recording medium 262. The main magnetic pole layer 121 is tapered not only in the film surface orthogonal direction P but also in the track width direction T (sheet surface orthogonal direction of FIG. 1) near the air bearing surface 110 to generate a minute and strong writing magnetic field in accordance with the high recording density.

The auxiliary magnetic pole layer 122 is a magnetic layer magnetically coupled with the main magnetic pole layer 121. The auxiliary magnetic pole layer 122 is a magnetic pole layer, formed of an alloy composed of any two or three of any of Ni, Fe, Co or the like, with a film thickness between approximately 0.01 μm and approximately 0.5 μm. The auxiliary magnetic pole layer 122 is disposed in a manner of branching from the main magnetic pole layer 121 and faces the main magnetic pole layer 121 with the gap layer 124 and a coil insulating layer 125 therebetween on the air bearing surface 110 side. The end part of the auxiliary magnetic pole layer 122 on the air bearing surface 110 side forms a trailing shield part in which the layer cross-section is wider than other parts of the auxiliary magnetic pole layer 122. The magnetic field gradient between the auxiliary magnetic pole layer 122 and the main magnetic pole layer 121 becomes steeper in the vicinity of the air bearing surface 110 by providing this type of auxiliary magnetic pole layer 122. As a result, the signal output jitter is reduced, and the error rate during reading can be lowered.

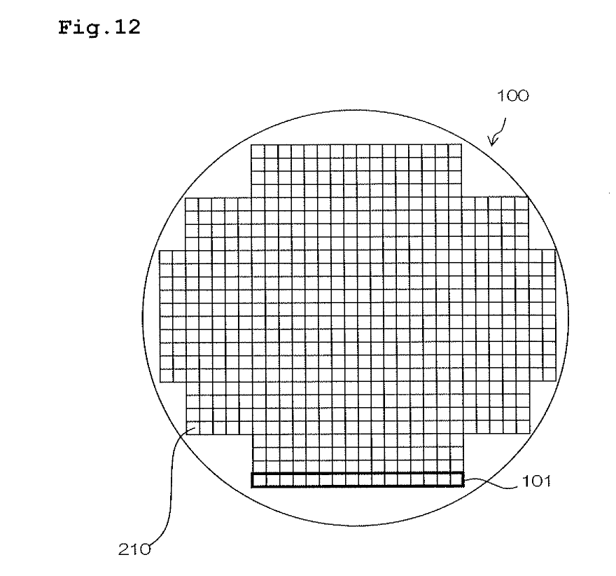

Next, a description is given regarding a wafer that is used for manufacturing the above-described magnetic head. Referring to FIG. 12, multilayer films that configure at least the above-described magnetic heads are formed on a wafer 100. The wafer 100 is divided into a plurality of bars 101 that are an operational unit for performing a polishing process on the air bearing surface. Further, the bar 101 is cut after the polishing process and is separated into sliders 210 each including the thin film magnetic head. In the wafer 100, a cut margin (not shown) for cutting the wafer 100 into the bar 101 and the bar 101 into the slider 210 is disposed.

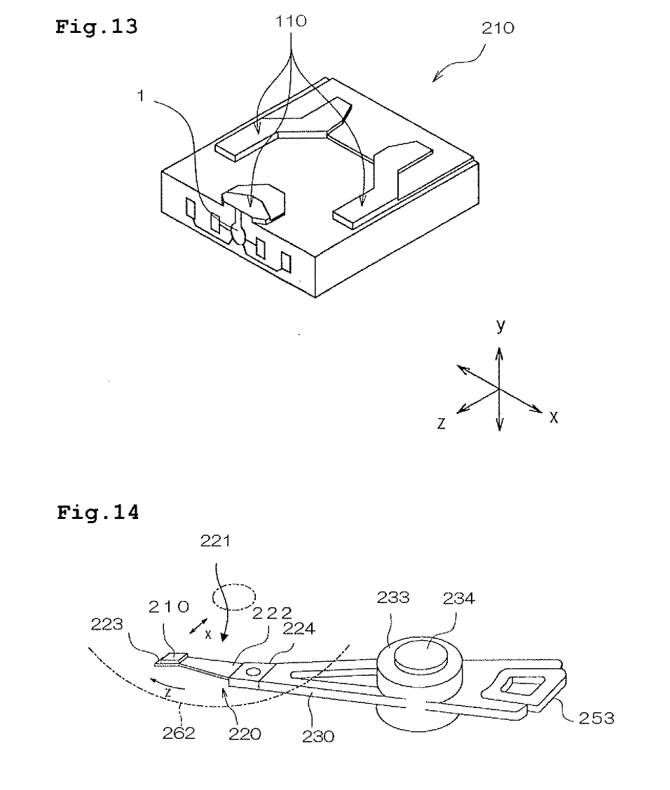

Referring to FIG. 13, a slider 210 has a substantially hexahedral shape, and one surface of the six outer surfaces is the air bearing surface 110 that faces a hard disk.

Referring to FIG. 14, a head gimbal assembly 220 includes the slider 210 and a suspension 221 elastically supporting the slider 210. The suspension 221 includes a load beam 222, a flexure 223 and a base plate 224. The load beam 222 is formed of stainless steel in a plate spring shape. The flexure 223 is arranged in one edge part of the load beam 222. The base plate 224 is arranged in the other edge part of the load beam 222. The slider 210 is joined to the flexure 223 to give the slider 210 suitable flexibility. At the part of the flexure 223 to which the slider 210 is attached, a gimbal part is disposed to maintain the slider 210 in an appropriate orientation.

The slider 210 is arranged in the hard disk device so as to face the hard disk, which is a disk-shaped recording medium 262 that is rotatably driven. When the hard disk rotates in the z-direction of FIG. 14, air flow passing between the hard disk and the slider 210 generates a downward lifting force to the slider 210. The slider 210 flies above the surface of the hard disk due to the lifting force. In the vicinity of the edge part of the slider 210 (edge part in bottom left of FIG. 13) on the air flow exit side, the thin film magnetic head 1 is formed.

An assembly in which the head gimbal assembly 220 is mounted to an arm 230 is referred to as a head arm assembly. The arm 230 moves the slider 210 in a track width direction x of a hard disk 262. One edge of the arm 230 is attached to the base plate 224. To the other edge of the arm 230, a coil 253 that forms one part of a voice coil motor is attached. A bearing part 233 is disposed in the middle part of the arm 230. The arm 230 is rotatably supported by a shaft 234 attached to the bearing part 233. The arm 230 and the voice coil motor for driving the arm 230 configure an actuator.

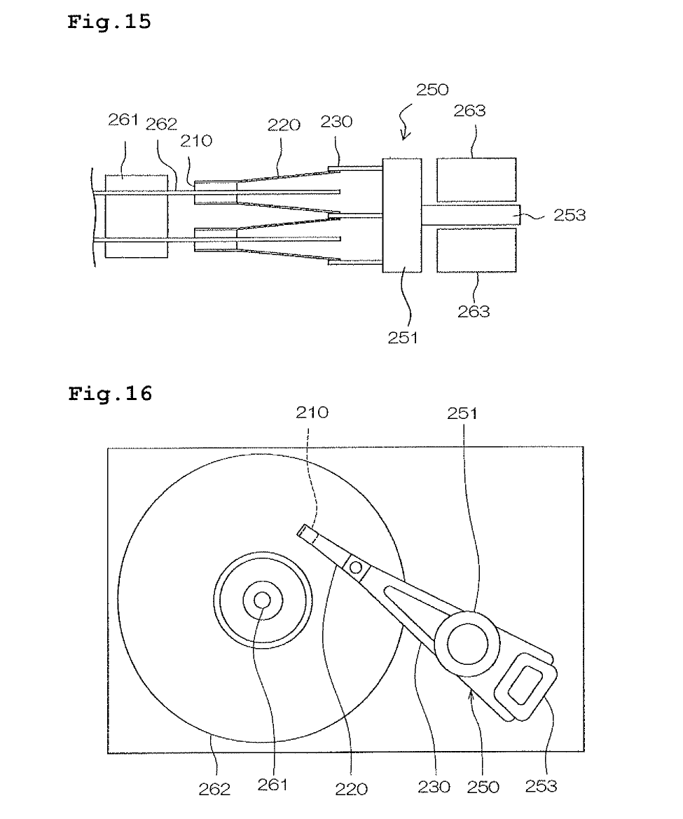

Next, referring to FIGS. 15 and 16, a description is given with regard to a head stack assembly in which the above-described slider is integrated, and the hard disk device. The head stack assembly is an assembly in which the head gimbal assembly 220 is attached to each arm of a carriage including a plurality of the arms. FIG. 15 is a side view of the head stack assembly, and FIG. 16 is a plan view of the hard disk device. The head stack assembly 250 includes a carriage 251 including a plurality of arms 230. On each of the arms 230, the head gimbal assembly 220 is attached such that the head gimbal assemblies 220 align mutually at an interval in the vertical direction. On the side, which is the opposite side of the arm 230, of the carriage 251, a coil 253 is mounted to be a part of the voice coil motor. The voice coil motor includes permanent magnets 263 arranged in the position where the permanent magnets 263 face with each other sandwiching the coil 253.

Referring to FIG. 16, the head stack assembly 250 is integrated in the hard disk device. The hard disk device includes multiple hard disks 262 attached to a spindle motor 261. For each of the hard disks 262, two sliders 210 are arranged in a manner of sandwiching the hard disk 262 and facing each other. The head stack assembly 250 except for the slider 210 and the actuator correspond to a positioning device of the present invention, support the slider 210 and position the slider 210 with respect to the hard disk 262. The slider 210 is moved in the track width direction of the hard disk 262 by the actuator, and is positioned with respect to the hard disk 262. The thin film magnetic head 1 included in the slider 210 records information to the hard disk 262 with the writing part, and reproduces information recorded on the hard disk 262 with the reading part.

While preferred embodiments of the present invention have been shown and described in detail, and it is to be understood that variety of changes and modifications may be made without departing from the spirit of scope of the attached claims or its scope.

What is claimed is:

1. A magnetic head that reads information of a magnetic recording medium, comprising:
a magneto resistance effect element (MR element), formed with multilayer films, of which an electrical resistance changes according to an external magnetic field;
a first shield layer that is disposed on a lower side in an lamination direction of the MR element;
a second shield layer that is disposed on an upper side in the lamination direction of the MR element and that applies voltage to the MR element together with the first shield layer; and
side shield layers that are disposed on both sides of the MR element in a first direction, the first direction being orthogonal to the lamination direction of the MR element and parallel to a surface facing the magnetic recording medium, wherein
the side shield layers include soft magnetic layers and hard magnetic layers magnetized in a predetermined direction.

2. The magnetic head according to claim 1, further comprising:
an anisotropy application layer that is disposed on an opposite side of the MR element with respect to the second shield layer and that provides exchange magnetic anisotropy to the second shield layer so as to magnetize the second shield layer in a predetermined direction.

3. The magnetic head according to claim 2, wherein
the MR element includes
a free layer of which a magnetization direction changes according to the external magnetic field, and
a magnetic coupling layer that is disposed between the second shield layer and the free layer and that exchange-couples the second shield layer with the free layer.

4. The magnetic head according to claim 3, wherein
a magnetization direction provided from the second shield layer to the free layer due to exchange coupling substantially corresponds to magnetization directions of the hard magnetic layers.

5. The magnetic head according to claim 2, wherein
the anisotropy application layer is an antiferromagnetic layer.

6. The magnetic head according to claim 5, further comprising:
nonmagnetic conductor layers between the side shield layers and the second shield layer, wherein
the MR element further includes a pinned layer of which a magnetization direction is pinned against the external magnetic field, a pinning layer including an antiferromagnetic layer that pins the magnetization direction of the pinned layer, and a spacer layer that is disposed between the pinned layer and the free layer.

7. The magnetic head according to claim 6, wherein
the pinned layer is magnetized in a direction substantially perpendicular to a surface facing the magnetic recording medium, and the hard magnetic layers are magnetized substantially in the first direction.

8. The magnetic head according to claim 6, wherein
an annealing treatment is performed on an antiferromagnetic layer configuring the anisotropy application layer after another annealing treatment is performed on an antiferromagnetic layer of the pinning layer, and
a magnetization treatment is performed on the hard magnetic layers of the side shield layers after the annealing treatment is performed on the antiferromagnetic layer configuring the anisotropy application layer.

9. The magnetic head according to claim 1, further comprising:
an anisotropy application layer that is disposed on an opposite side of the MR element with respect to the first shield layer and that provides exchange magnetic anisotropy to the first shield layer so as to magnetize the first shield layer in a predetermined direction.

10. The magnetic head according to claim 9, wherein
the MR element includes
a free layer of which a magnetization direction changes according to the external magnetic field, and
a magnetic coupling layer that is disposed between the first shield layer and the free layer and that exchange-couples the first shield layer with the free layer.

11. The magnetic head according to claim 10, wherein
a magnetization direction provided from the first shield layer to the free layer due to exchange coupling substantially corresponds to the magnetization directions of the hard magnetic layers.

12. The magnetic head according to claim 9, wherein
the anisotropy application layer is an antiferromagnetic layer.

13. The magnetic head according to claim 12, further comprising:
nonmagnetic conductor layers between the side shield layers and the first shield layer, wherein
the MR element further includes a pinned layer of which a magnetization direction is pinned against the external magnetic field, a pinning layer including an antiferromagnetic layer that pins the magnetization direction of the pinned layer, and a spacer layer disposed between the pinned layer and the free layer.

14. The magnetic head according to claim 13, wherein
the pinned layer is magnetized in a direction substantially perpendicular to a surface facing the magnetic recording medium, and the hard magnetic layers are magnetized substantially in the first direction.

15. The magnetic head according to claim 1, wherein
the MR element includes a free layer of which a magnetization direction changes according to the external magnetic field, a pinned layer of which a magnetization direction is pinned against the external magnetic field, a pinning layer including an antiferromagnetic layer that pins the magnetization direction of the pinned layer, and a spacer layer that is disposed between the pinned layer and the free layer, and
the pinned layer, the soft magnetic layers, and the hard magnetic layers are extended longer than the free layer in a direction perpendicular to a surface facing the magnetic recording medium.

16. The thin film magnetic head according to claim 1, wherein
the soft magnetic layers are positioned on lower sides of the hard magnetic layers in the lamination direction and are extended along entire surfaces of the side shield layers facing the MR element.

17. A slider, comprising:
the thin film magnetic head according to claim 1.

18. A wafer on which a lamination film, which is to be the thin film magnetic head according to claim 1, is formed.

19. A head gimbal assembly, comprising:
the slider according to claim 17; and
a suspension that elastically supports the slider.

20. A hard disk device, comprising:
the slider according to claim 17; and
a device that positions the slider with respect to the recording medium as well as supports the slider.
